(19) United States
(12) Patent Application Publication
(10) Pub. No.: US 2012/0288627 A1
(43) Pub. Date: Nov. 15, 2012

(54) THREE-DIMENSIONAL ELECTROMAGNETIC METAMATERIALS AND METHODS OF MANUFACTURE

(75) Inventors: John W. Hodges, JR., Ocoee, FL (US); Marc Rippen, Clearwater, FL (US); Carl J. Biver, JR., Belleair, FL (US)

(73) Assignee: SRI INTERNATIONAL, Menlo Park, CA (US)

(21) Appl. No.: 13/514,271

(22) PCT Filed: Dec. 17, 2010
(86) PCT No.: PCT/US2010/061156

§ 371 Date: Jun. 6, 2012

Related U.S. Application Data
(60) Provisional application No. 61/288,219, filed on Dec. 18, 2009.

(51) Int. Cl. B05C 5/02; B05D 1/26

(52) U.S. Cl. 427/265; 118/704

(57) ABSTRACT

In certain embodiments, a method may include a computing device generating a digital representation of a metamaterial structure and sectioning the digital representation to generate a plurality of substantially two-dimensional layer layouts. The method may also include a printing device sequentially fabricating each of a plurality of substantially two-dimensional layers based on a corresponding one of the plurality of substantially two-dimensional layer layouts.

### CROSS-REFERENCE TO RELATED APPLICATION

This application claims the benefit of U.S. Provisional Patent Application Ser. No. 61/288,219, titled “METHOD AND APPARATUS FOR MANUFACTURING ELECTROMAGNETIC META MATERIALS OF THREE-DIMENSIONS” and filed on Dec. 18, 2009, which is hereby incorporated by reference herein in its entirety.

### TECHNICAL FIELD

The disclosed technology pertains to three-dimensional electromagnetic metamaterials and methods of manufacturing metamaterial structures.

### BACKGROUND

Metamaterials have the potential to solve many of the problems presented by conventional materials in the development of wide-band, physically small components and subsystems. Metamaterials may offer a promising alternative that could potentially overcome certain limitations of current conventional technologies. Metamaterial technology is considered by many to be a breakthrough technology due to its ability to efficiently guide and control electromagnetic waves.

There is an emerging need, however, for wide-band/multi-band device functionality, e.g., devices that can wirelessly, through RF means, for example, operate with nearly uniform performance over a broad frequency range. Evolution to multi-modal devices is envisioned where, ideally, components and sub-systems would be dynamic, re-configurable and multifunctional.

### BRIEF DESCRIPTION OF THE DRAWINGS

FIG. 1 is a table that provides ranges of electric permittivity and magnetic permeability as graphed in a two-dimensional Cartesian space.

FIG. 2 is a flowchart that illustrates an example of a method of manufacturing a metamaterial structure in accordance with embodiments of the disclosed technology.

FIG. 3 is a flowchart that illustrates an example of a method of fabricating each of a plurality of two-dimensional layers to produce a metamaterial structure in accordance with embodiments of the disclosed technology.

FIGS. 5-7 illustrate three discrete stages during fabrication of a metamaterial structure corresponding to the digital representation illustrated in FIG. 4.

FIG. 8 illustrates an example of a metamaterial structure resulting from the process illustrated in FIGS. 5-7.

FIGS. 9 and 10 illustrate further examples of metamaterial structures in accordance with embodiments of the disclosed technology.

### DETAILED DESCRIPTION

As used herein, the term metamaterial generally refers to an artificially created, i.e., non-naturally occurring, material that is designed to have particular properties that may not be available in naturally occurring material. For example, metamaterials may exhibit certain electromagnetic properties on a macroscopic level that are generally not found in naturally occurring material. Metamaterials generally gain these properties from their structure rather than from their composition. The characteristics of a metamaterial may differ from the typical behavior of the components from which it is composed. Certain metamaterials may gain their properties from the shape or arrangement of the material used as well as the boundary effects on radio frequency (RF) or electromagnetic (EM) waves that transition through the metamaterial.

The properties of a metamaterial may include electric permittivity s and magnetic permeability μ. As used herein, the term permittivity generally refers to a measure of how much resistance is encountered responsive to the forming of an electric field in a medium. Permittivity generally refers to a quantification of how an electric field both affects and is affected by a dielectric medium. Permittivity typically relates to a material's ability to transmit an electric field because it is generally determined by an ability of the material to polarize in response to the electric field.

As used herein, the term permeability generally refers to the measure of an ability of a material to support the formation of a magnetic field within itself. Permeability generally refers to the degree of magnetization that a material may obtain responsive to an applied magnetic field.

Conventionally, electric and magnetic fields follow what is termed as the right-hand rule, which provides that an electric current flowing through a conductor results in a magnetic flux revolving around the conductor in a clockwise direction as observed from the direction of the source of the current. This is termed the right-hand rule because, while extending the thumb of one's right hand, the direction that one's fingers curl indicates the direction in which the induced magnetic flux revolves.

In certain situations, a material can exist in which the flow of the electric current causes magnetic flux of an opposite sense, revolving in a counter-clockwise direction from the perspective of the source of the current. Such situations are generally referred to as states of left-handedness and, in such situations, the material is said to follow what is termed as the left-hand rule. Early left-handed materials generally used some form of split-ring resonator structures that are too bulky for most practical applications and, more importantly, are strongly limited by their resonant nature. That is, a decent bandwidth may be obtained if their Q factor is small but transmission losses will be unacceptable. If their Q factor is large, however, low-loss transmission is possible but bandwidth will generally be too narrow for most signal transmissions.

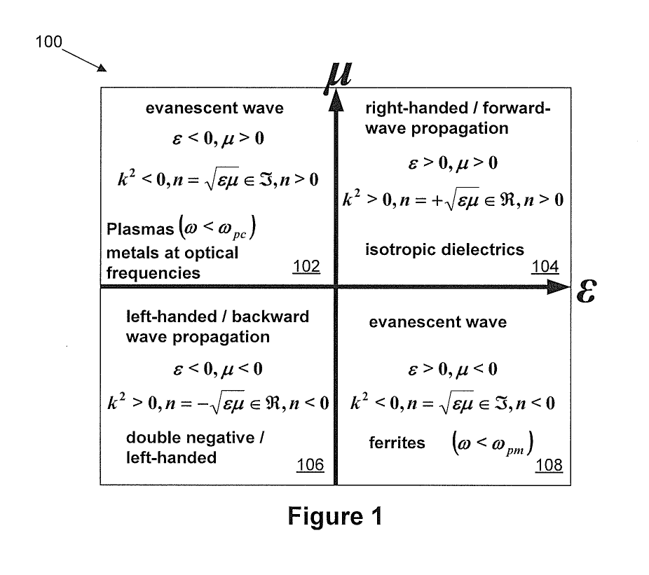

FIG. 1 is a table 100 that provides ranges of electric permittivity and magnetic permeability as graphed in a two-dimensional Cartesian space. Conventional right-handed materials generally have positive values of electric permittivity s and magnetic permeability μ. Therefore, as shown in FIG. 1, the properties of natural materials tend to fall in the upper-right quadrant 104. The properties of left-handed materials or metamaterials that have negative values of both electric permittivity and magnetic permeability tend to fall in the lower-left quadrant 106. The other two quadrants 102, 108 pertain to composite right/left-handed (CRLH) metamaterials. A negative refractive index typically results from a simultaneous negative permeability and negative permittivity. In this case, backward wave propagation can occur and the phase velocity is anti-parallel to the group velocity. The electromagnetic field vector, the magnetic field vector, and the wave vector can form a left-handed-oriented system, in contrast to the conventional right-handed sense.

A transmission line approach to metamaterials associated with non-resonant type structures originally led to the concept of composite right/left-handed (CRLH) metamaterials, which in turn led to an entire suite of guided-wave, radiated-wave, and refracted-wave applications. CRLH metamaterials represent a paradigm shift in electromagnetic engineering due to their rich dispersion and fundamental right/left-hand duality. CRLH structures are typically created from an array of a structures referred to as a unit cell that are arranged in a certain manner, and can be one-dimensional (1D), two-dimensional (2D), or three-dimensional (3D). 1D and 2D CRLH materials have been demonstrated and have been used to some effectiveness in a select range of products but 3D materials and, in particular, Substrate Integrated Artificial Dielectric (SIAD) structures have proven difficult and expensive to manufacture. 3D CRLH-based SIAD structures offer certain advantages because they are paraelectric and paramagnetic. These structures may provide enhancement of both the permittivity and permeability of a given host substrate and, therefore, achieve guided wavelength compression that may lead to circuit size miniaturization in virtually all RF circuits, particularly for government and commercial applications.

Traditional manufacturing of 3D CRLS-based SIAD structures may be grouped into two broad areas: 1) subtractive techniques, such as using electronic discharge machining, laser ablation, or chemical etching; and 2) additive techniques, such as using compound printed wiring boards or various laminate layups. Both types of techniques tend to be prohibitively expensive. For metamaterials to gain broader industrial use, a low-cost scalable manufacturing technique is required, particularly to drive such technology toward government and commercial markets. In addition, the complexity of the unit cells themselves has been limited by the limitations imposed by the particular manufacturing technique.

The techniques described herein may be implemented to manufacture a metamaterial RF-based CRLS-based SIAD structure that, in particular geometries, is not constrained in any physical plane. Because these structures are non-planar, they are limited only by the size of whatever system is used to fabricate them. Accordingly, the electromagnetic performance of engineered devices may be significantly enhanced and, in certain cases, lead to various unprecedented functionalities.

Metamaterial structures fabricated in accordance with embodiments can be implemented in connection with radio frequency (RF) devices to include RF metamaterial SIAD substrates, patch antennas, power dividers, filters, and low observables, for example. As used herein, the term low observables generally refers to aircraft, ships, and other vehicles and equipment that present minimal possibilities of detection by electromagnetic, visual, sound, and/or heat detection systems. In other embodiments, metamaterial structures can be used in connection with power generation to include metamaterial battery structures and thermoelectric generators, for example. In further embodiments, metamaterial structures can be used in connection with advanced magnetics applications to include metamaterial magnetic and ferrites that far surpass conventional rare-Earth magnet materials. In yet other embodiments, metamaterial structures can be used for thermal control to include metamaterial heat conduction mechanisms similar to those found in heat sinks and heat exchangers.

Embodiments of the disclosed technology describe methods for producing three-dimensional electromagnetic materials, and, more specifically, to producing electromagnetic metamaterial structures having particular magnetic and electric properties. For example, such structures may include arrays of inductors and capacitors arranged to produce a negative impedance effect at lower frequencies than currently possible in order to create an RF metamaterial. In certain embodiments, a suitable printing device or printer may be used to fabricate the structure from a plurality of two-dimensional layers producing metamaterials whose electric permittivities and magnetic permeabilities can conform to a left-hand rule and the metamaterial produced thereby.

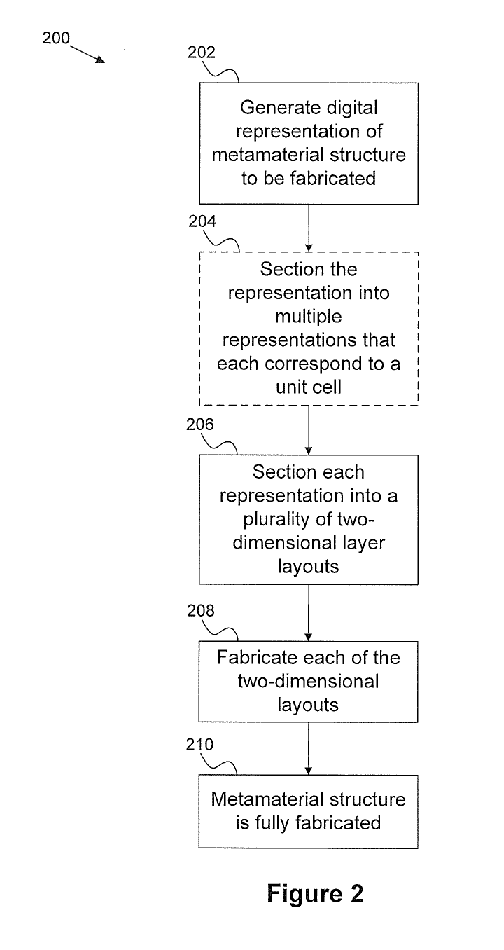

FIG. 2 is a flowchart that illustrates an example of a method 200 of manufacturing a metamaterial structure. At 202, the system generates a digital representation of a three-dimensional electromagnetic metamaterial structure, which may include one or more unit cells, and stores the digital representation of the structure in a computer memory, for example. Alternatively, or in addition, the digital representation may be stored elsewhere such as in a database or external storage device. In certain embodiments where the digital representation has already been generated, the system may instead receive or retrieve the previously generated representation rather than generate a new one.

If the metamaterial structure is to include multiple unit cells, the system next sections the digital representation into a plurality of digital representations that each corresponds to one of the unit cells, as shown at 204. At 206, the system sections the digital representation into a plurality of distinct substantially two-dimensional layer layouts. If there are multiple digital representations, the system may section each representation before proceeding. Alternatively, the system may section one of the digital representations and proceed through one or more additional portions of the process before sectioning the next representation.

At 208, a printing device fabricates a substantially two-dimensional layer in accordance with each of the plurality of substantially two-dimensional layer layouts. The printing device continues fabricating the layers until an actual metamaterial structure corresponding to the digital representation of the structure has been completed, as shown at 210. As used herein, a metamaterial structure is considered to be non-planar as it is generally not restricted to a single plane. Indeed, the number of planes that a given structure can encompass is virtually unlimited.

In certain embodiments, each fabricated layer has a thickness of 0.004″. In other embodiments, each layer may have a different thickness. Additionally, the thickness may change during production of the structure based on any of a number of different conditions. For example, certain materials and/or certain components of the design may require a different thickness during one or more stages of printing.

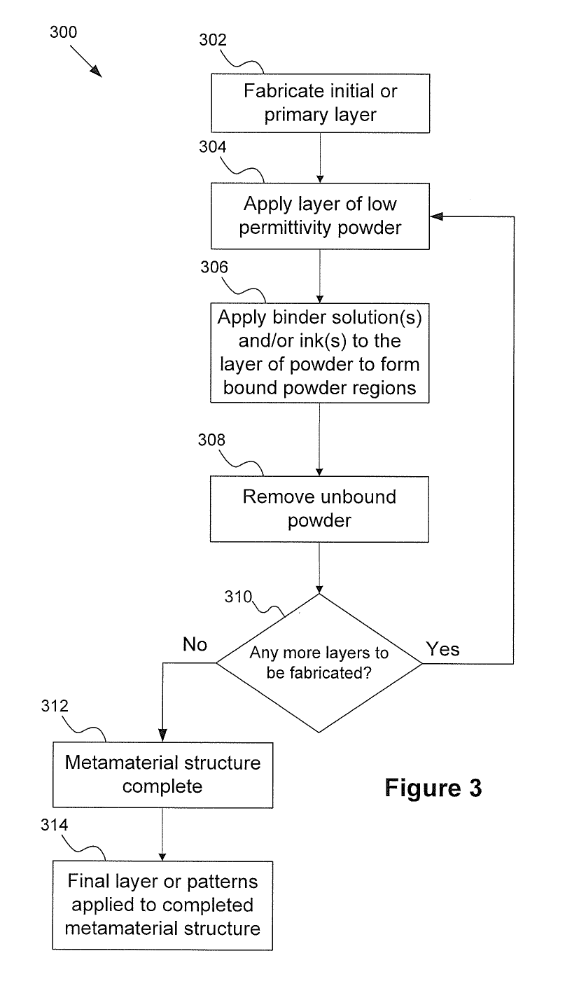

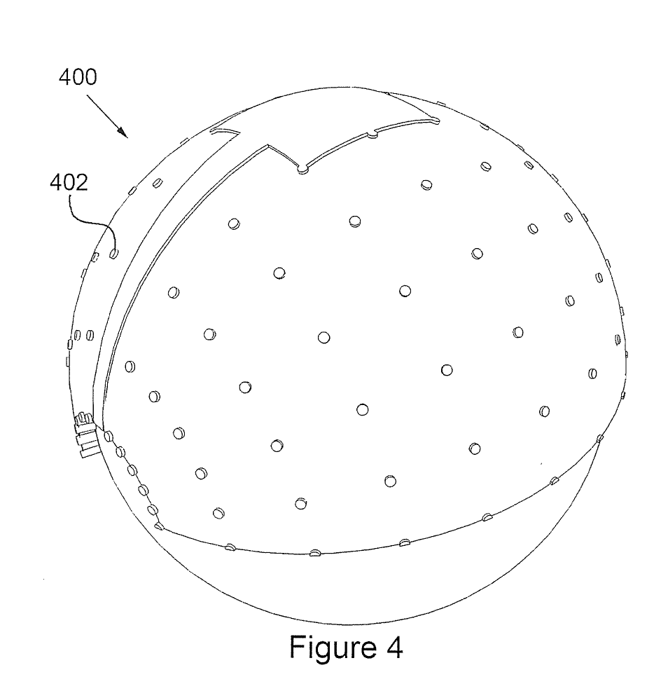

FIG. 3 is a flowchart that illustrates an example of a method 300 of fabricating each of a plurality of substantially two-dimensional layers to produce a metamaterial structure. At 302, an initial or primary layer is fabricated using a three-dimensional printing device. In certain embodiments, the primary layer is made at least primarily of a conductive material. In other embodiments, the primary layer may be made of a partially or fully insulating material. In certain embodiments, the primary layer has an arbitrary shape. In other embodiments, the primary layer may have a predefined shape.

The printing device then fabricates on the primary layer a substantially two-dimensional layer corresponding to one of a plurality of two-dimensional layer layouts that, when taken together, make up a digital representation of a metamaterial structure. In the example, the printing device fabricates the two-dimensional layer by first applying a layer of a low electromagnetic permittivity powder on the primary layer, as shown at 304. The powder may include, but is not limited to, CaSo₄. Certain powders may be adjusted for RF properties in a confined area.

At 306, one or more of a plurality of binder solutions or inks are applied to the two-dimensional layer. The binder solutions and/or inks may include nano-magnetic powders with either high electromagnetic conductivity or high electromagnetic permeability. In certain embodiments, the binder solutions and/or inks may be selectively deposited on the two-dimensional layer to produce regions of bound powder for the layer as sectioned by the system to create one or more unit cells.

At 308, the unbound powder is removed. In other words, at least substantially all of the powder applied at 304 that has not been bound as a result of the binder solution and/or ink applied at 306 is removed. Removal of the unbound powder may be performed by air-driven techniques. Alternatively, or in addition, the removal may be accomplished using any of a number of chemical techniques.

At 310, the system determines whether the substantially two-dimensional layer corresponds to the last of the plurality of substantially two-dimensional layer layouts. If so, the system proceeds to 312; otherwise, the system returns to 304 and fabricates on top of the most-recently-formed two-dimensional layer a two-dimensional layer that corresponds to the next one of the plurality of two-dimensional layer layouts. Accordingly, the process at 304 through 308 is essentially repeated until a two-dimensional layer corresponding to each of the plurality of distinct two-dimensional layer layouts have been created.

At 312, a three-dimensional metamaterial structure is now fully fabricated and may be used for any of a number of applications. As noted above, such structures may include one or more unit cells. Taken together, the various fabricated two-dimensional layers may form an electromagnetic Substrate Integrated Artificial Dielectric (SIAD) structure having certain negative values or electric permittivity and magnetic permeability.

Optionally, a final layer or top surface patterns of a conductive material may be applied to create a circuit having certain properties, as shown at 314.

FIG. 4 illustrates an example of a digital representation 400 of a metamaterial structure to be fabricated using any of the techniques described herein. The digital representation 400 may be generated using any of a number of techniques such as computer-aided design (CAD) software. In the example, the digital representation 400 corresponds to a patch antenna. The digital representation 400 includes a number of different components 402 to be integrated as part of the design. In the example, the components 402 function as capacitors and are used to improve antenna functionality.

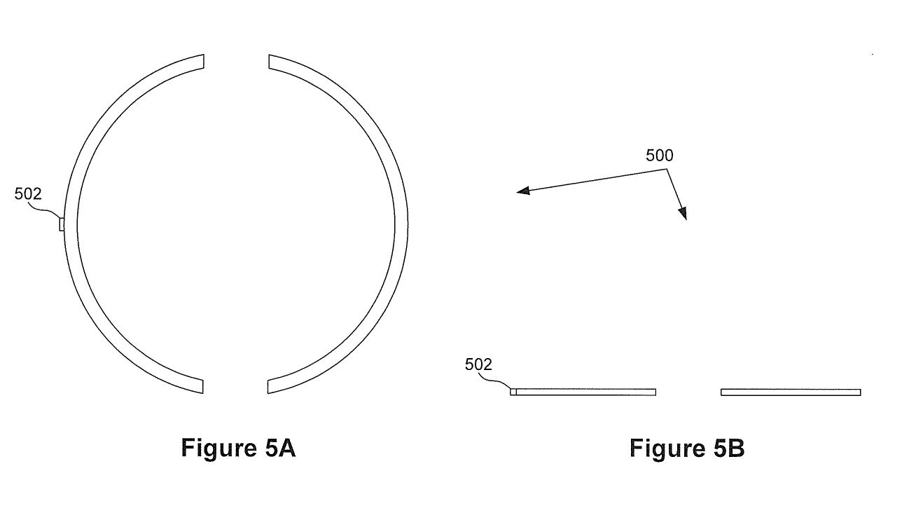

FIGS. 5-7 illustrate three discrete stages 500-700, respectively, during fabrication of a metamaterial structure corresponding to the digital representation 400 illustrated in FIG. 4. FIG. 5 illustrates a first stage 500 of fabrication in which only a first two-dimensional layer has been fabricated. In the example, the first layer includes a first portion of a component 502 that corresponds to one of the components 402 of FIG. 4. For simplicity, only one component 502 is illustrated in FIG. 5. The first stage layer 500 may be fabricated using the process described in 304-308 of FIG. 3, for example. FIG. 5A shows a top view of the layer and FIG. 5B shows a side view of the layer. This first layer corresponds to the first of a plurality of layer layouts and is fabricated using a suitable printing device. In the example, the first layer has a thickness of 0.004″.

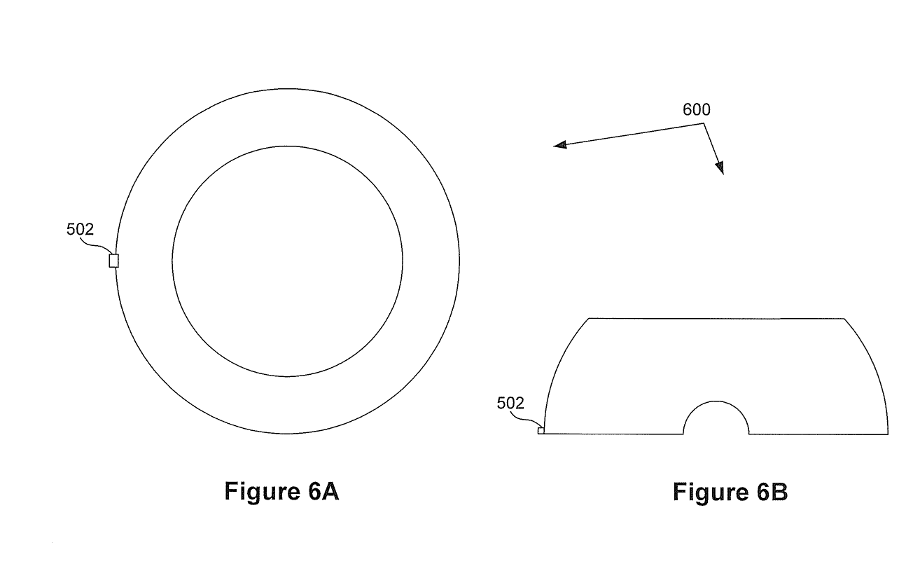

FIG. 6 illustrates a middle stage 600 of fabrication in which many two-dimensional layers have been applied. FIG. 6A shows a top view of the structure and FIG. 6B shows a side view of the structure. In the example, approximately half of the layers to be fabricated have been fabricated and the particular component 502 first presented in FIG. 5 has been fully fabricated.

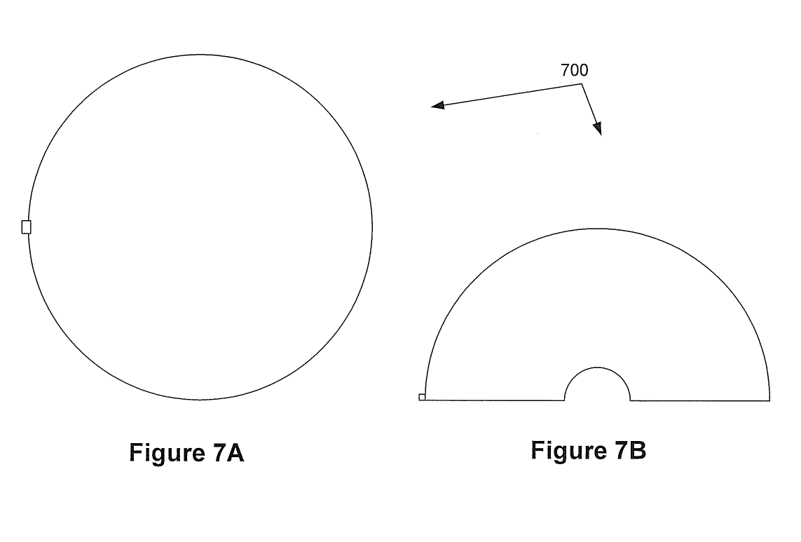

FIG. 7 illustrates a final stage 700 of fabrication in which the metamaterial structure has been fully fabricated. FIG. 7A shows a top view of the structure and FIG. 7B shows a side view of the structure.

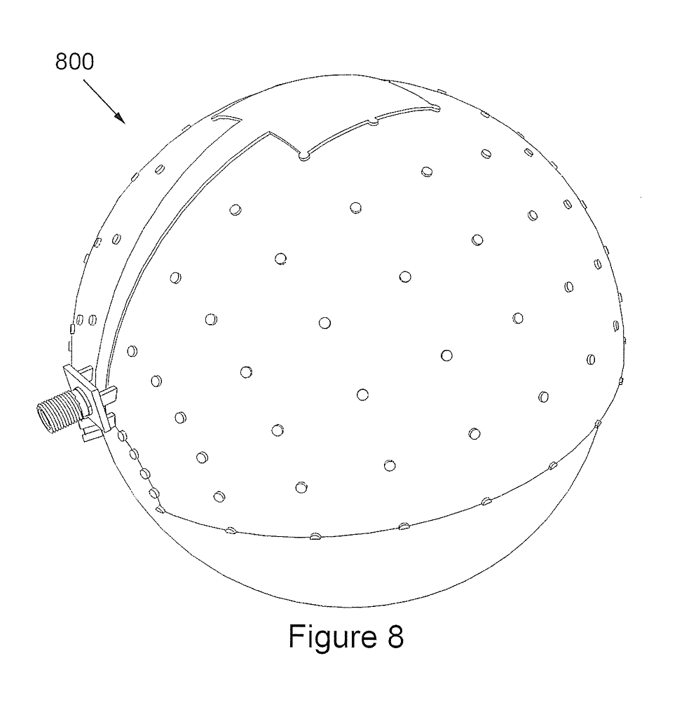

FIG. 8 illustrates an example of a metamaterial structure 800 resulting from the process illustrated in FIGS. 5-7. One having ordinary skill in the art will readily recognize that the metamaterial structure 800 corresponds to both the final stage 700 of fabrication as shown in FIG. 7 as well as the digital representation 400 illustrated in FIG. 4. In the example, the CRLH SIAD structure used as a patch antenna is placed on top of a baseball to provide a greater perspective in terms of the size and shape of the resulting metamaterial structure 800.

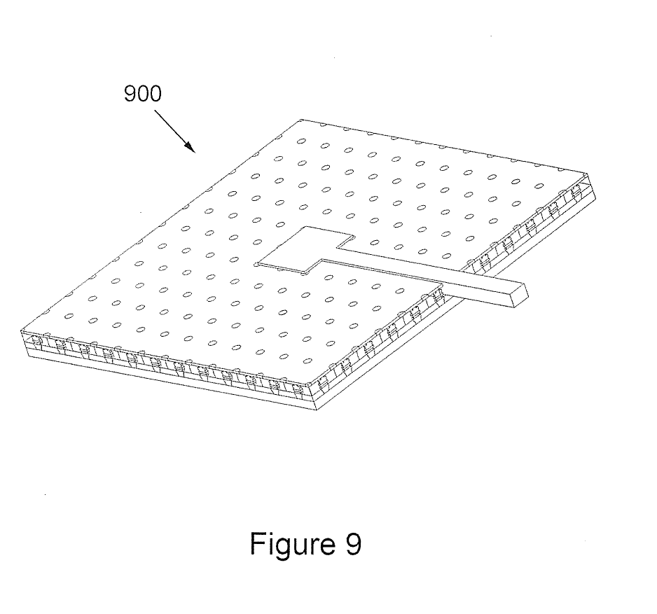

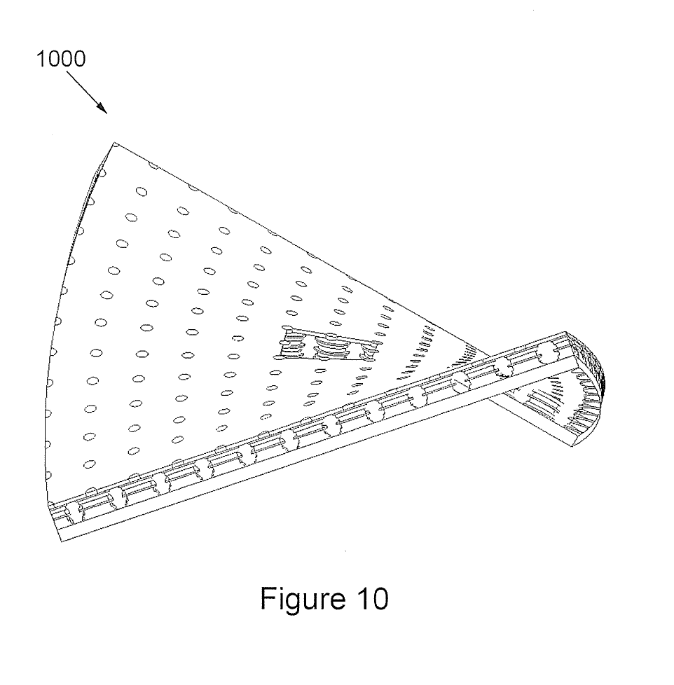

FIGS. 9 and 10 illustrate further examples of different metamaterial structures 900 and 1000, respectively, that may be fabricated using the techniques described herein. In certain embodiments, metamaterial structures fabricated in accordance with the techniques described herein may be at least substantially rigid. Alternatively, at least a portion of the structure may have some degree of flexibility, depending primarily on the materials used to fabricated the structure.

Properly manufacturing a metamaterial can improve the effective parameters of a given host substrate by up to 100% for the permittivity and up to 40% for the permeability, corresponding to a guided wavelength compression factor of up to 67%. In other words, substantially similar or identical performance may be achieved with up to a significantly smaller physical size. Techniques such as those described herein may provide an ability to manipulate the size, flexibility, and dispersion properties of microwave circuits, for example. Accordingly, highly complex unit cells can have vastly improved performance and at a reduced cost. This enhanced performance is due, at least in part, to an increase in the number of inductors and capacitors per unit cell.

Certain embodiments may include the use of very fine powders, typically 6 (−1250) mesh, that have a very low effective permittivity εᵣ and an effective permeability of 1. The powders that may be used in connection with the techniques described herein may include one or more of the following:
SiO₂
Al₂O₃
Polystyrene
Polycarbonate
Polymethyl methacrylate (PMMA)
Various clays including, but not limited to, Redart's and Gypsum

Whichever powder or powders are used for a certain two-dimensional layer may be selectively mixed with a suitable binder that, when activated by a suitable ink, form solid portions that are fired or left “green.” Any of the following may be used as binders:
PVA (polyvinyl alcohol)
PVAc (polyvinyl acetate)
Maltodextrin
Sucrose
Glucose
Sodium hydroxide
Sodium carbonate

Many of the electrical, magnetic, and thermal properties may be gained by the inks, including whatever may be carried in each ink. In certain embodiment, these inks may be composed of one or more of the following:
Water
Polyethylene glycol
Propylene glycol
Glycerin
Poly (3, 4-oxyethyleneoxythiophene)/poly (styrene sulfonate) (PEDOT/PSS) 1.3 wt. % dispersion in water.
Ethylene glycol
Silver nitrate (e.g., 99.999% pure)
Metalon JS-011 silver ink with 10% loading
Metalon ICI-001 copper ink with 10% loading
In97/Ag3 size 6 powder
X-nano MICR Black HD-2a
Bi₂Te₃
Bi₂Se₃
Various surfactants
   In certain embodiments that involve the use of purchased inks, such inks may be used as a base and added to a mixture.

In certain embodiments in which a conductor is modeled as a simple patch antenna, varying the conductivity does not effectively change the frequency of operation for the antenna. Also, a more rapid change in the S11 parameter tends to take place when the frequency of operation increases. This is generally because of the skin effect pushing the antenna to a higher impedance value when the frequency increases. The effects of conductivity on the antenna efficiency and gain have also been studied. As these parameters are very prone to be affected by losses in the antenna, the parts apart from conductors were chosen as lossless, but there are still very minor losses present due to dielectric layer.

Certain inkjet cartridges that can be used dispense small volumes of material, e.g., 150 picolitres. Traditional metal-filled conductive adhesives cannot typically be processed by ink jetting because of their relatively high viscosity and the size of filler material particles. The smallest droplet size typically achievable by traditional dispensing techniques is in the range of 150 μm, yielding proportionally larger adhesive dots on the powders due to percolation. Electrically conductive inks are available on the market with metal particles, such as copper or silver<20 nm, suspended in a solvent at 10-50 wt %. With these inks after deposition, the solvent is typically eliminated and electrical conductivity is enabled by a high metal ratio in the residue. Some of these inks include a sintering step. Such nano-filled inks do not offer an adhesive function. Inks used in connection with the techniques described herein, however, generally perform both functions. That is, such inks perform as both an adhesive and as a conductive ink.

Two distinct paths may be followed to achieve a conductive layer. The first method includes growing a PEDOT-silver composite conductor by growing in-situ silver with a PMMA binder that can be printed by a Z-Corp inkjet printing cartridge, for example. This first method may be accomplished as follows:
1. Preparation of Conductive polymer based (PEDOT-PSS) ink. Polyethylene dioxythiophene (PEDOT) polystyrene sulfonate (PSS)—80% Ethylene Glycol—20%.
2. Preparation of Silver Nitrate and Glucose Solution for in-situ deposition of silver. Silver nitrate solution—8 ml water heated to 50-60° C., 2 ml Ethylene glycoll and 0.70 gm AgNo3 are added.
   The PEDOT-silver composite fabrication is a two step process. First, PEDOT is printed on a PMMA\glucose\sodium hydroxide binder using an inkjet micro droplet deposition. Then, in-situ silver lines are grown on top of the PEDOT lines by printing the silver nitrate solution alternatively. Both solutions may be loaded in separate cartridges.

The second method for achieving electrical conductivity described here includes incorporating transient liquid phase metallic fillers in ink formulations. The filler to be used is typically a mixture of a high-melting-point metal powder, such as Ag, and a low-melting-point alloy powder, such as In. The low-melting-alloy filler melts when its melting point is achieved at approximately 144° C. cure, which is below the 200° C. melting point of the PMMA. The liquid phase dissolves the high-melting-point Ag particles. The liquid exists only for a short period of time and then forms an alloy and solidifies. The electrical conduction is established through a plurality of metallurgical connections in-situ formed from these two powders in the PMMA binder. The PMMA binder with an acid functional ingredient fluxes both the metal powders and facilitates the transient liquid bonding of the powders to form a stable metallurgical network for electrical conduction, and also forms an interpenetrating polymer network providing adhesion.

The incorporate transient liquid-phase ink jettable, isotropically conductive binder typically has a two-step curing mechanism. In the first step, the adhesive is dispensed, e.g., jetted, and then procured, thereby leaving a “dry” surface. The second step consists of assembly by activating the TLP by final curing at 144° C.

### General Description of a Suitable Machine in Which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smart phones, and the like. These machines may be implemented as part of a cloud computing arrangement.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A method, comprising:
a computing device generating a digital representation of a metamaterial structure;
the computing device sectioning the digital representation to generate a plurality of substantially two-dimensional layer layouts; and
a printing device sequentially fabricating each of a plurality of substantially two-dimensional layers based on a corresponding one of the plurality of substantially two-dimensional layer layouts.

2. The method of claim 1, wherein the fabricating comprises the printing device fabricating a substantially two-dimensional primary layer.

3. The method of claim 2, wherein the fabricating further comprises the printing device depositing a layer of powder on the substantially two-dimensional primary layer.

4. The method of claim 3, wherein the powder comprises at least one of SiO₂, Al₂O₃, polystyrene, polycarbonate, and polymethyl methacrylate.

5. The method of claim 3, wherein the fabricating further comprises the printing device applying at least one of at least one ink and at least one binding solution to the layer of powder to form at least one region of bound powder within the layer of powder.

6. The method of claim 5, wherein the at least one ink comprises at least one of water, polyethylene glycol, propylene glycol, glycerin, ethylene glycol, silver nitrate, Bi₂Te₃, and Bi₂Se₃.

7. The method of claim 5, wherein the at least one binding solution comprises at least one of polyvinyl alcohol, polyvinyl acetate, maltodextrin, sucrose, glucose, sodium hydroxide, sodium carbonate.

8. The machine-controlled method of claim 5, wherein the fabricating further comprises removing the layer of powder except for the at least one region of bound powder within the layer of powder.

9. The machine-controlled method of claim 8, wherein the removing comprises applying one of an air-driven process and a chemical process to the layer of powder.

10. The machine-controlled method of claim 8, wherein the fabricating further comprises the printing device depositing another layer of powder on the metamaterial structure.

11. The machine-controlled method of claim 10, wherein the fabricating further comprises the printing device applying at least one ink to the other layer of powder to form at least one region of bound powder within the other layer of powder.

12. The machine-controlled method of claim 11, wherein the fabricating further comprises removing the other layer of powder except for the at least one region of bound powder within the other layer of powder.

13. The machine-controlled method of claim 2, wherein the fabricating further comprises the printing device fabricating a substantially two-dimensional final layer.

14. The machine-controlled method of claim 1, wherein the printing device comprises an inkjet printer.

15. The machine-controlled method of claim 1, wherein the metamaterial structure comprises a patch antenna.

16. A system, comprising:
a computing device configured to section a digital representation of a metamaterial structure to generate a plurality of substantially two-dimensional layer layouts; and
a printing device configured to sequentially fabricate the metamaterial structure by fabricating each of a plurality of substantially two-dimensional layers based on a corresponding one of the plurality of substantially two-dimensional layer layouts.

17. The system of claim 16, wherein the printing device is configured to fabricate each of the plurality of substantially two-dimensional layers by depositing a layer of powder.

18. The system of claim 17, wherein the printing device is further configured to fabricate each of the plurality of substantially two-dimensional layers by applying at least one of an ink and a binding solution to the layer of powder to form at least one region of bound powder within the layer of powder.

19. The system of claim 18, further comprising a powder removal unit configured to remove the layer of powder except for the at least one region of bound powder within the layer of powder.

20. The system of claim 16, further comprising a memory device configured to store at least one of the digital representation of the metamaterial structure and the plurality of substantially two-dimensional layer layouts.
